(19) United States
(12) Patent Application Publication
(10) Pub. No.: US 2011/0001753 A1
(43) Pub. Date: Jan. 6, 2011

(54) METHOD, MODULE, AND DEVICE FOR DISPLAYING GRAPHICAL INFORMATION

(76) Inventors: Johan Frej, Goteborg (SE); Anders Larsson, Malmo (SE); Mikael Tellhed, Malmo (SE); Karl-Anders Johansson, Malmo (SE)

Correspondence Address: HARNESS, DICKEY & PIERCE, P.L.C., P.O. BOX 8910, RESTON, VA, 20195, US

(21) Appl. No.: 12/735,173

(22) PCT Filed: Dec. 18, 2008
(86) PCT No.: PCT/EP2008/010830

§ 371 Date: Sep. 14, 2010

Related U.S. Application Data
(62) Division of application No. 61/015,923, filed on Dec. 21, 2007.

(30) Foreign Application Priority Data
Dec. 21, 2007 (SE) 0702912-7

(51) Int. Cl. G06F 13/00

(52) U.S. Cl. 345/536; 345/530

(57) ABSTRACT

A method, module and device for displaying graphical information on a screen are provided. In at least one embodiment, the method includes composing resulting image data from at least one application service, and transmitting the resulting image data to the screen. Further, in at least one embodiment, the composing of the resulting image data includes identifying items associated with each of the at least one application service, determining at least one item that is in a visible state, fetching information associated with the at least one item that is in a visible state, and calculating the resulting image data from the fetched information.

This is a National Phase of PCT Patent Application No. PCT/EP2008/010830, filed on Dec. 18, 2008, which claims priority under 35 U.S.C. §119 to Swedish Patent Application No. 0702912-7, filed on Dec. 21, 2007, and U.S. Provisional Application No. 61/015,923, filed on Dec. 21, 2007, the contents of each of which are hereby incorporated by reference in their entirety.

### TECHNICAL FIELD OF THE INVENTION

The present invention relates to a method for displaying graphical information on a screen of a device. The present invention also relates to a computer program product, a module and a device for displaying graphical information.

### BACKGROUND ART

Software applications are usually presented on a display connected to a device controlled by a computer. The graphical user interface (GUI), which allows a user to interact with the device, typically comprises both information about the processing status of the software applications, as well as surrounding graphics that helps the user to understand and interpret the software applications.

Traditionally, GUI systems on personal computers or mobile phones present an image on the display using a software that directly controls the position and look of the applications. Each application is normally created by a programmer who has the ultimate control of where a certain graphical element should appear, what it should contain, and how it should behave. When an application is initialized, the GUI system presents all elements directly to the display on top of each other, and there are generally no efficient processes to implement movements or animations of the elements.

Also, programmers typically populate the elements with data that may actually never be displayed, just because the GUI system requires it.

To some extent, there are other methods for addressing the problem of creating graphically rich user interfaces. There are e.g. techniques allowing the graphical designer, instead of the programmer, to completely define the GUI. Even if such techniques may reduce the required processing power in comparison with how software applications are displayed traditionally, they still require a lot of memory due to the fact that the programmer needs to push all application data into the design level in order for it to be readily available for the designer.

Thus, it is necessary to optimize how software applications are presented on a device display.

US 2004/0021659 describes a system for generating an image. The image comprises subject graphics data, corresponding to the processing status of an application, and a GUI. The subject graphics data and the GUI data originate from a single graphics application program, and they are decoupled for purposes of rendering. The system includes a first graphics pipeline for rendering the subject graphics image, which can be thought of as the contents of a window in the graphics application. This yields rendered subject graphics data. The invention also includes a second graphics pipeline for rendering the GUI graphics. This yields rendered GUI graphics data. Third, the invention includes a compositor for compositing the rendered subject graphics data produced by the first graphics pipeline, and the rendered GUI graphics data produced by the second graphics pipeline.

Efficient methods for displaying software applications are particularly imperative within portable electronic devices. Such devices are restricted in comparison to desktop computers, e.g. with respect to the central processing unit, available memory, memory architecture, real-time operating system, and display resolution. Moreover, in most cases there are no hardware graphics accelerators in portable electronic devices. Thus, there is still a need for an efficient method for displaying software applications.

### SUMMARY OF THE INVENTION

The word “application service” is herein referred to computer software configured to communicate with a graphical user interface presented on a screen. Thus, application services involve computer software that is capable of providing information to be presented to the user, e.g. a media player service, a contact manager service, a messenger service, a web browser service etc.

The word “item” is herein referred to an object that may be presented graphically to a user. In case of a media player, an item may e.g. be a navigation button, a window or a menu. Further, an item may also refer to a part of a navigation button, a part of a window or a part of a menu.

The word “module” is herein referred to a software module, a hardware module such as an ASIC, or a combination thereof such as a FPGA.

An “element” should be interpreted as being equal to an item.

In view of the foregoing, it is an object of the present invention to provide an improvement of the above techniques and prior art. More particularly, it is an object of the invention to provide an advanced graphical user interface while reducing the necessary processing power and memory resource. Another object of the invention is to provide a method which enables efficient displaying of animations, movements and effects.

At least some of the above objects are achieved by means of a method, a computer program product, a module and a device according to the independent claims. Specific embodiments of the invention are set forth in the dependent claims.

According to a first aspect of the invention, a method for displaying graphical information on a screen of a device is provided. The method comprises the steps of composing resulting image data from at least one application service, and transmitting the resulting image data to the screen of the device. The step of composing resulting image data further comprises identifying items associated with each of the at least one application service, determining at least one item that is in a visible state, fetching information associated with the at least one item that is in a visible state, and calculating the resulting image data from the fetched information. The method is advantageous in that several application services can be presented in an efficient manner with reduced processing power.

The step of identifying items may be performed prior to the step of determining at least one item that is in a visible state, and the step of determining at least one item that is in a visible state may be performed prior to the step of fetching information.

The step of fetching information may only fetch information associated with the at least one item that is in a visible state, which is advantageous in that minimum information is used to compose the resulting image data. Further, it is advantageous in that the items which are not in a visible state are excluded from being transmitted to the screen, whereby the quantity of information that is transmitted to the screen is reduced.

The step of fetching information may further comprise the steps of fetching data associated with each of the at least one item in the visible state from a first memory, and fetching graphical declarations associated with each of the at least one item in the visible state from a second memory. This enables programmers to define application data, and graphical designers to define the graphical appearance of the application services.

The step of fetching graphical declarations may further comprises the step of connecting to a remote server, wherein said server comprises the second memory. The appearance of application services can thus correspond to the appearance of e.g. user accounts on the internet.

The method may further comprise the step of calculating at least one attribute of each identified item, wherein the attribute is selected from a group consisting of position, size and rotation. This provides efficient handling of items when the appearance of the items are changed.

The step of determining at least one item that is in a visible state may further comprise the steps of determining items which are in a non-visible state, and determining items which are in a partially visible state. This is advantageous in that items are categorized in a feasible manner.

The method may further comprise the step of receiving command data corresponding to an event triggered by input data, wherein the step of composing resulting image data is repeated for every received command data. Thus, resulting image data can be transmitted to the screen when triggered by e.g. user input, moving animations etc., thus providing smooth animations and movements of graphical items.

According to a second aspect of the invention, a computer program product comprising program code means stored in a computer readable medium is provided. The program code means are adapted to perform any of the steps of the method according to the first aspect of the invention when the program is run on a computer. The advantages of the first aspect of the invention are also applicable to the second aspect of the invention.

According to a third aspect of the invention, a module for displaying graphical information on a screen of a device is provided. The module comprises a compositor configured to compose resulting image data from at least one application service, and a transmitter configured to transmit the resulting image data to the screen of the device. The compositor further comprises an identifier configured to identify items associated with each of the at least one application service, a determinator configured to determine at least one item that is in a visible state, a fetching means configured to fetch information associated with the at least one item that is in the visible state, and a calculator configured to calculate the resulting image data from the fetched information. The advantages of the first aspect of the invention are also applicable to the third aspect of the invention.

The fetching means may only fetch information associated with the at least one item that is in a visible state.

The fetching means may comprise a first fetching means configured to fetch data associated with each of the at least one item that is in the visible mode from a first memory, and a second fetching means configured to fetch graphical declarations associated with each of the at least one item that is in the visible mode from a second memory.

The second memory may be arranged on a remote server.

The module may further comprise a second calculating means configured to calculate at least one attribute of each identified item, wherein the attribute is selected from a group consisting of position, size and rotation.

The second determinator may be configured to determine items which are in a non-visible state, and to determine items which are in a partially visible state.

The module may further comprise a receiver configured to receive command data corresponding to an event triggered by input data, wherein the command data is configured to control the compositor.

According to a fourth aspect of the invention, a device is provided. The device comprises means for initializing at least one application service, a module according to the third aspect of the invention, and a screen configured to display the image data. The advantages of the first aspect of the invention are also applicable to the fourth aspect of the invention.

The device may be a mobile terminal.

According to a fifth aspect of the invention, a system comprising a device according to the fourth aspect of the invention is provided. The system further comprises a remote server which is connected to the device, wherein the remote server is storing information associated with the at least one application service. This is advantageous in that the appearance of application services can correspond to the appearance of e.g. user accounts on the internet.

### BRIEF DESCRIPTION OF THE DRAWINGS

Embodiments of the present invention will now be described, by way of example, with reference to the accompanying schematic drawings.

FIG. 1 is a schematic workflow of a method for providing a user interface according to prior art.

FIG. 2 is a schematic workflow of a method for providing a user interface according to one embodiment of the present invention.

FIG. 3 shows schematically a method according to one embodiment of the present invention.

FIG. 4 shows a hierarchic structure of a user interface.

FIG. 5 shows an example of image data displayed on a screen of a mobile terminal.

FIG. 6 shows a hierarchic representation of a software application corresponding to the image data as shown in FIG. 5.

FIG. 7 shows another example of image data displayed on a screen of a mobile terminal.

FIG. 8 shows a hierarchic representation of software applications corresponding to the image data as shown in FIG. 7.

FIG. 9a-c shows different devices according to the fourth embodiment of the present invention.

FIG. 10 is a schematic view of a system according to one embodiment of the fifth aspect of the invention.

### DETAILED DESCRIPTION OF PREFERRED EMBODIMENTS

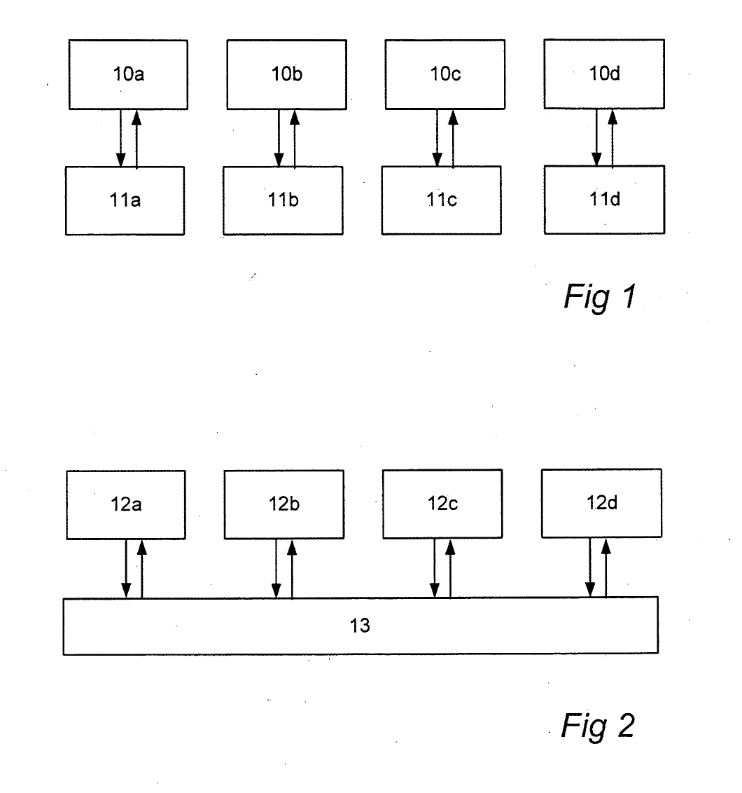

FIG. 1 is a schematic workflow of a method according to prior art. In such a method, the GUI system is directly transmitted to a device screen by a computer software generally known as a window manager. As shown in FIG. 1, four different software applications 10a, b, c and d are running in parallel. The software applications may e.g. be a messenger application 10a, a media player application 10b, a contacts list application 10c and a calendar application 10d. Each software application is directly associated with a corresponding user interface 11a, b, c and d, i.e. the messenger application 10a is associated with a messenger user interface 11a, the media player application 10b is associated with a media player user interface 11b, the contacts list application 10c is associated with a contacts list user interface 11c and the calendar application 10d is associated with a calendar user interface 11d. The messenger user interface 11a creates graphical items, handles user interface events and controls the user interface flow as defined by the messenger application 10a. Correspondingly, the user interfaces 11b, c and d are configured to operate similarly. Each user interface 11a, b, c and d occupies specific pixels of the screen. In some cases, a single pixel will be addressed by two or more of the user interfaces 11a, b, c and d. Since all application user interfaces 11a, b, c and d are drawn directly to the screen, a pixel that is used by all four user interfaces 11a, b, c and d will then be drawn four times.

FIG. 2 is a schematic workflow of a method according to one embodiment of the present invention. As shown in FIG. 2, four different application services 12a, b, c and d are running in parallel on a computer controlled device. Each one of the application services 12a, b, c and d is associated with a common user interface 13. In a specific embodiment, the application services 12a, b, c and d corresponds to a messenger service 12a, a media player service 12b, a contacts list service 12c and a calendar service 12d. The common user interface 13 is configured to receive events from each application service 12a, b, c, and d, fetch data and initiate processes. In one embodiment, this can be exemplified by the user interface 13 receiving an event of an incoming call, fetching data of who is calling, and establishing the phone call. Each of the application services 12a, b, c and d occupies specific pixels of the screen, i.e. four application services contribute to the graphical scene. Since the application user interface 13 is drawn to the screen, a pixel that is occupied by all four application services 12a, b, c and d will then be drawn only once.

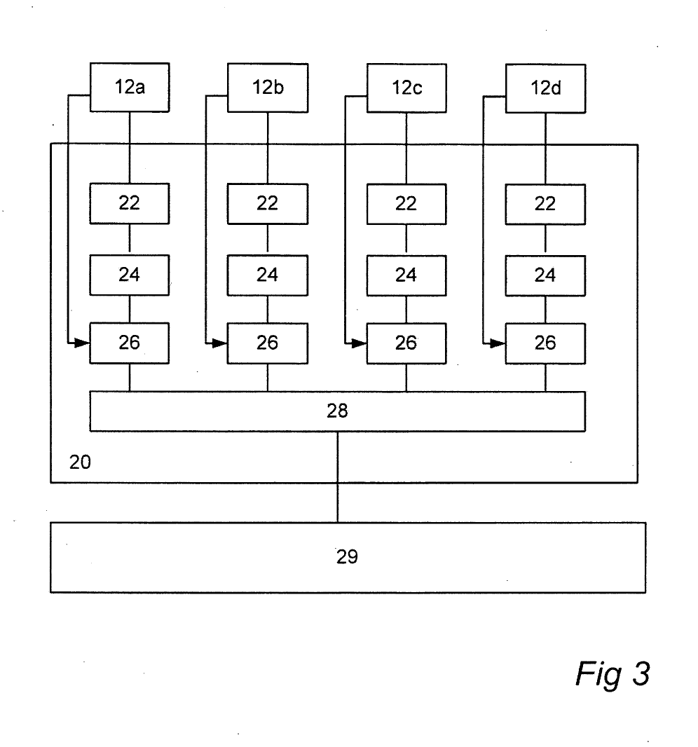

In FIG. 3, the method according to one embodiment is illustrated. The method provides a user interface, i.e. graphical information, to be presented on a screen of a device. According to FIG. 3, four different application services 12a, b, c, and d are running. In one step 20 of the method, resulting image data is composed. The resulting image data is transmitted to the screen of the device in step 29. The step of composing resulting image data 20 is further described with reference to FIG. 3. In step 22, items associated with each of the application services 12a, b, c and d are identified. More specifically, the items which are located within the graphical scene are identified. In one embodiment, the graphical scene corresponds to the actual size of the screen of the device. In another embodiment, the graphical scene corresponds to a scene that is somewhat larger than the size of the screen of the device. In case of contacts list service, the graphical scene contains the number of contacts which are visible on the screen plus a specific number of contacts before and after the visible contacts in order to enhance a scrolling activity.

The step of identifying items 22 may also comprise calculating parameters of the items. If one item change its size, this will probably affect the layout of surrounding items as well. Therefore, the position, size, rotation, color, opaqueness, etc are calculated for all items in the graphical scene.

After the step of identifying items 22, in step 24 the method determines which of the identified items are in a visible state. In this step, items which are positioned behind solid items or arranged outside the visible screen of the device are determined to be in a non-visible state. Consequently, in step 24 the method determines which of the identified items are in a visible state, a non-visible state, as well as which of the identified items are in a partially visible state. This can be applied to items in a two-dimensional (2D) space as well as to items in a three-dimensional (3D) space. In 2D space, two or more items may overlap but only the item in front will be determined to be in a visible state. However, in 3D space items may be overlapping or not overlapping depending on view angles, shadowing etc. Also in this case the item in front will be determined and set as being in a visible state.

In step 26 information associated with the items in the visible state and the partially visible state is fetched. More particularly, application service data is fetched from a hard coded memory. If one item in the visible state or the partially visible state is associated with a data reference pointer, the appointed data is fetched from a XML-file containing graphical declarations. In specific embodiments, the data reference pointer can also address an image, a video file, a sound file etc. Only information associated with the items determined to be in a visible state or a partially visible state is fetched.

The information is fetched from two different resources. Data associated with the application service 12a is fetched from a first memory, and graphical declarations associated with the application service 12a is fetched from a second memory. The second memory can e.g. be located on a remote server, and the graphical declarations can thus correspond to a personal profile on an internet account. The application data and the graphical declarations are used to compose the resulting image data.

In one embodiment, application data are hard coded instructions which are programmed in e.g. C or C++ by an application service programmer. The graphical declarations control the layout, appearance and animations of the software applications. The information associated with graphical declarations is represented by the XML-file which is defined by a graphical designer.

Next, the resulting image data is calculated in step 28. The calculating step 28 uses the fetched information as input, i.e. information associated with several items is composed to a single resulting image data. Thereafter, the resulting image data is transmitted to the screen of the device in step 29, wherein the method is repeated in order to provide a continuous user interface.

When providing a dynamic user interface, the method is repeated in order to provide smooth transitions and movements of items. A command data is first received, corresponding to an event triggered by input data. The input data may be a user input, such as the user pushing a button, or an initiated animation that is used to create a special effect. Thus, the step of composing resulting image data 20 is repeated for every received command data or during the length of an animation sequence.

The fetched information is stored temporarily in a cache. When the user interface is changed during a dynamic sequence, the cached information may be removed from the cache when the state of an item is changed from visible to non-visible. However, the composing step may further comprise a step of evaluating if a previously visible item will be visible again. Thus, if an item in the visible state is hidden by e.g. an animation, the composing step will evaluate the animation and the information will be retained in the cache so the information associated with the temporary non-visible item will be easily accessed when the animation no longer hides the item.

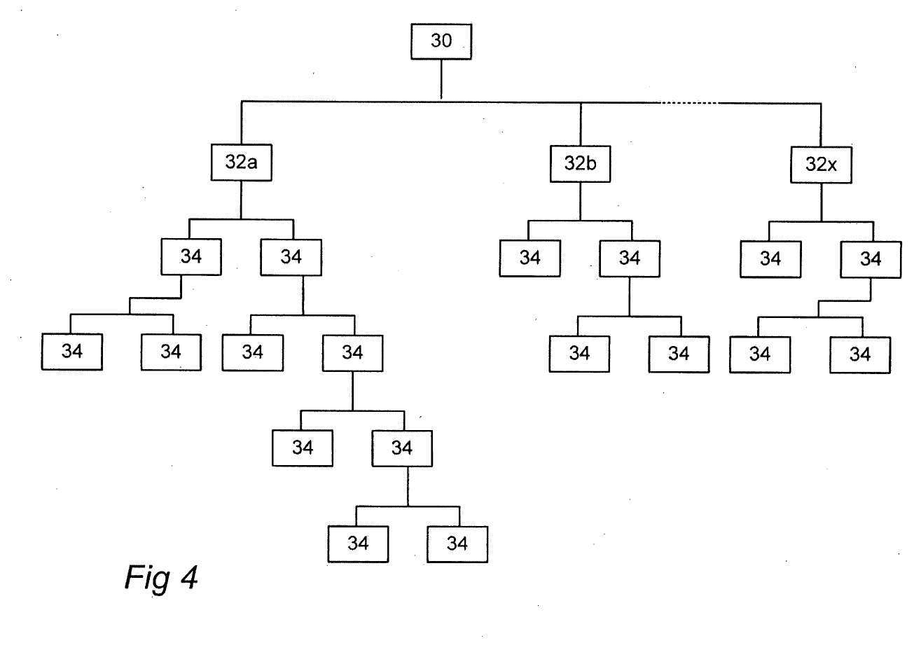

The user interface is represented by a tree structure. FIG. 4 shows a tree structure 30 representing the user interface of several application services 32a, b, . . . , x. Each node 32a, b, . . . , x corresponding to different application services has different levels of items 34 associated with them. When an application service is running, the composing step 20 will address the items of the application service to vacant positions 34 of the empty node 32a. When several application services are running in parallel, the composing step 20 will address the items of the application services to vacant positions 34 of the empty node 32a, b, etc.

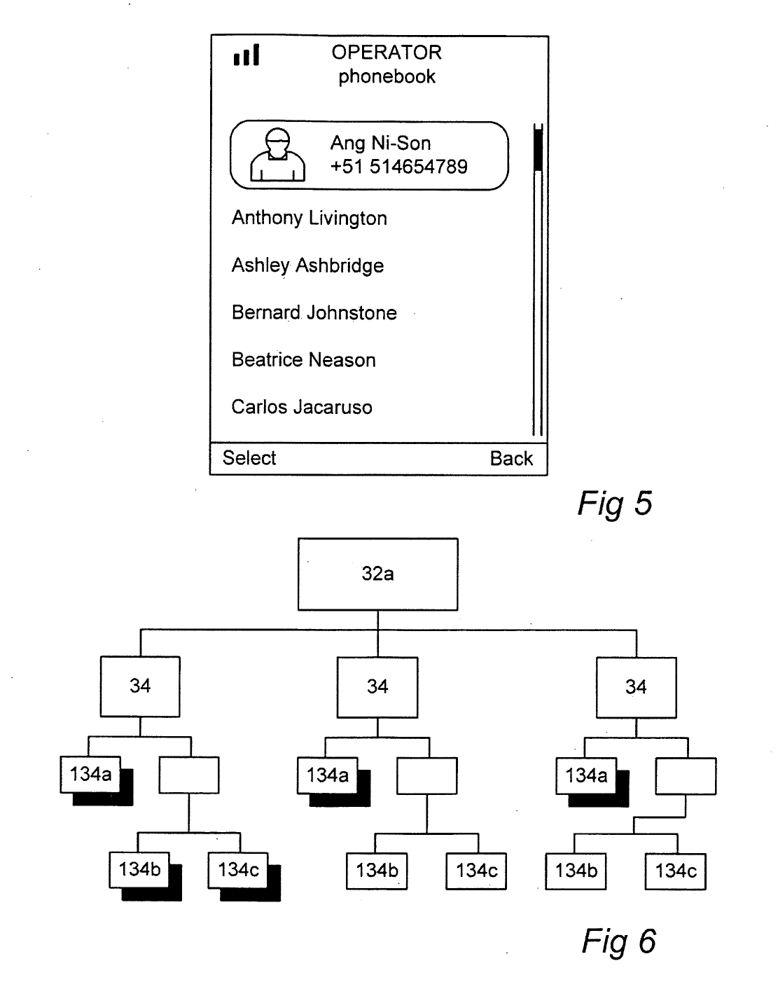

With reference to FIGS. 5 and 6, one embodiment of a method displaying one application service will be described in more detail. FIG. 5 shows a snapshot of a graphical user interface displayed on the screen of a mobile terminal. At the top of the screen, the user is notified of the current operator, and a label informs the user that the phonebook is accessed. At the bottom of the screen, a navigation menu allows the user to either select a certain contact or return to a prior navigation position. A scroll bar at the right indicates the approximate position in the phonebook list. When a certain contact is highlighted, the phonebook is programmed to change the appearance in order to show a picture and the phone number of the contact.

As shown in FIG. 6, the phonebook correspond to a running application service and it is represented by a list 32a containing a number of list items 34, 134. A first text array 134a, a second text array 134b and a picture 134c are associated with each list item 34 in a tree structure. The first text array 134a contains the name of the contact, the second text array 134b contains the telephone number of the contact, and the picture 134c is e.g. a picture of the contact. Only three items 34 are shown in FIG. 6, however the actual number of list items in the user interface tree structure equals the number of contacts visible on the screen plus some contacts before and after, thus enhancing scrolling processes. In this embodiment, the three list items 34 in FIG. 6 corresponds to the first three contacts in the list shown in FIG. 5. The shadowed boxes in FIG. 6 illustrates the information displayed in FIG. 5. For the highlighted contact the name, phone number and picture are displayed. For the second and third contact in the list, only the name is displayed.

Returning to the method as shown in FIG. 3, the snapshot of FIG. 5 is created according to the following. First, the phone book application is initialized by a user, and items which are associated with the phone book application are identified, and determined if they are in a visible state, a partially visible state or a non-visible state. Thus, the text array 134a corresponding to the name of the highlighted contact, the text array 134b corresponding to the phone number of the highlighted contact and the picture 134c of the highlighted contact are determined to be in a visible state. Further, the text arrays 134a corresponding to the name of the subsequent contacts are also determined to be in a visible state. In a following step, application data and graphical declarations associated with the items in the visible state are fetched. As an example, the tree structure of the list items 34 is stored as application data, and the information is fetched from a hard coded memory circuit. Content, font size, color, blur, drop-shadow, anti-aliasing, position, movement etc for each item in the visible state are declared in a XML-file and fetched from a second memory.

By fetching only the relevant information, i.e. information associated with application items determined to be in a visible state or a partially visible state, the performance of the method is optimized. This means that information associated with the text array 134b corresponding to the phone number of the non-highlighted contact and the picture 134c of the non-highlighted contact are not fetched.

In a subsequent step, the fetched information is composed to resulting image data and transmitted to the screen of the device.

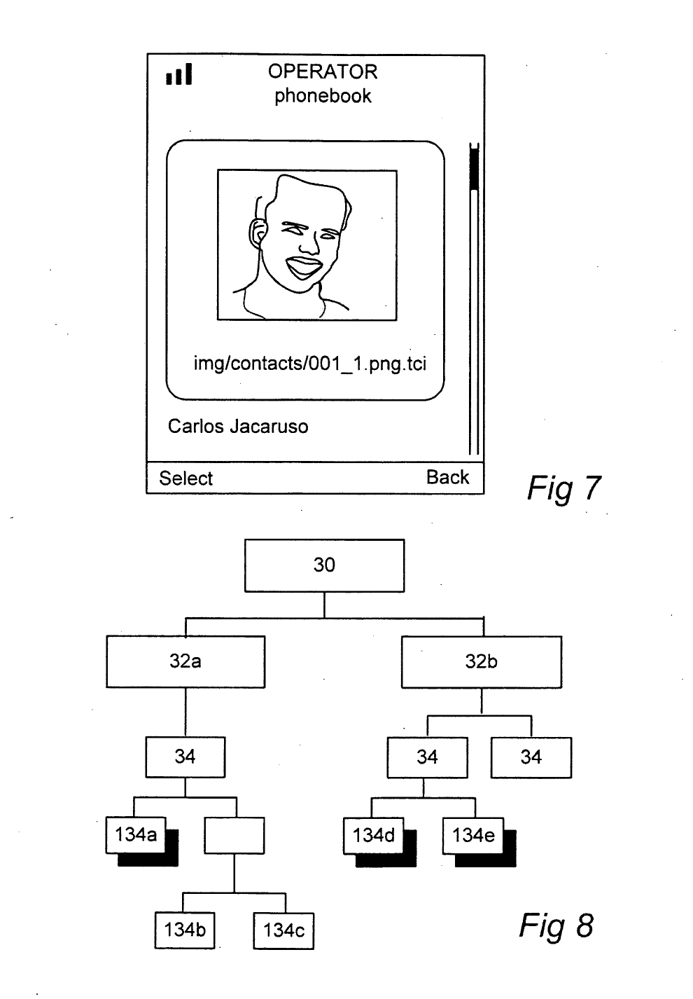

With reference to FIGS. 7 and 8, another embodiment of a method displaying two application services will be described in more detail. FIG. 7 shows a snapshot of a graphical user interface displayed on the screen of a mobile terminal. At the top of the screen, the user is notified of the current operator, and a label informs the user that the phonebook is accessed. At the bottom of the screen, a navigation menu allows the user to either select a certain contact or return to a prior navigation position. A scroll bar at the right indicates the approximate position in the list. When a certain contact in the contact list shown in FIG. 5 is selected, the phonebook will change the appearance such that a pop-up window containing information associated with the contact is shown. As shown in FIG. 7, the pop-up application service is programmed to show an enlarged image of the contact as well as the name of the image source.

As shown in FIG. 8, the user interface on the screen corresponds to two different application services represented by a list service 23a and a pop-up service 32b. The list service 32a is equivalent with the list service described in FIG. 6, containing a number of list items 34. A first text array 134a, a second text array 134b and a picture 134c are associated with each list item 34 in a tree structure. The first text array 134a contains the name of the contact, the second text array 134b contains the telephone number of the contact, and the picture 134c is e.g. a picture of the contact. Only one item is shown in FIG. 8, however the actual number of list items 34 equals the number of visible contacts on the screen plus a specific number of contacts before and after, enhancing scrolling processes. Thus, the list item 34 in FIG. 8 corresponds to the selected contact shown in FIG. 7. The shadowed box 134a of the list application 34 in FIG. 8 illustrates the displayed information. The pop-up service 32b also contains a number of items 34 having an image 134d and a text array 134e corresponding the image source associated to it. The shadowed boxes 134d, 134e of the pop-up service 32b in FIG. 8 illustrates the information displayed on the screen in FIG. 7.

Returning to the method as shown in FIG. 3, the snapshot of FIG. 7 is created according to the following. First, the phonebook service and the pop-up service are initialized, and items which are associated with the phone book service and the pop-up service are identified, and determined if they are in a visible state, a partially visible state or a non-visible state. Thus, the text array 134a in the list application corresponding to the name of the selected contact, the image 134d in the pop-up application corresponding to the selected contact and the text array 134e corresponding to the image source in the pop-up application are determined to be in a visible state. In a following step, application data and graphical declarations associated with the items in the visible state are fetched. As an example, the tree structures of the list item and the pop-up item are stored as application data, and the information is fetched from a hard coded memory circuit. Content, font size, color, blur, drop-shadow, anti-aliasing, position, movement, effects etc for each item in the visible state are declared in a XML-file and fetched from a second memory.

In a subsequent step, the fetched information is composed to resulting image data and transmitted to the screen of the device.

The XML-file containing graphical declarations of the application services comprises a sequence of XML tags. As an example, the comprehensive graphical appearance of the application services is also defined by XML tags. A page control may e.g. be represented by the following command.

<page id=”delContactsPage” title=”@langDb.delCTitle”

visuals=”stdPage” menuBarItemSource=”@delOptions”>

<list id=”delContactsList” itemSource=”@contacts” type=”check”

checkProperty=”checked” visuals=”stdList2” itemVisuals=”2rowItem4”/>

</page>

The page control contains a number of attributes, wherein the value of the id attribute is the name of the page control, the value of the title attribute is the title of the page as retrieved from a language database, the value of the visuals attribute is a reference to the visual representation of the page, and the value of the menuBarItemSource attribute is the reference to a model defining the softkey behavior of the page. Further, a list control is declared within the page control. The list control contains a number of attributes, wherein the value of the id attribute is the name of the list control, the value of the itemSource attribute is the reference to a model defining the contact items, the value of the type attribute defines that the list is a check list, the value of the checkProperty attribute defines which property should be used for checking or unchecking an item, the value of the visuals attribute is a reference to the visual representation of the list, and the value of the itemVisuals attribute defines which visuals should be used for the list items.

The method for displaying graphical information on a screen of a device as previously described may be implemented by a module. The module comprises a compositor configured to compose resulting image data from a number of running application services. Further, the module has a transmitter configured to transmit the resulting image data to the screen of a device. In more detail, the compositor has an identifier, a determinator, a fetching means and a calculator. During operation, the module is arranged to display a number of application services on a screen of a device. At least one of the application services occupies specific pixels of the screen, i.e. contributes to the graphical scene of the device. The identifier is configured to identify items associated with each application service, and the determinator determines which of the items are in a visible state, a non-visible state and a partially visible state. In a more particular embodiment, parameters such as position, size, rotation etc of the identified items may be calculated. The determinator will transmit information to the fetching means which is configured to fetch information associated with the items in the visible state or the partially visible state. The fetching means will fetch application data from a first memory and graphical declarations from a second memory.

The fetched information will be transmitted from the fetching means to the calculator. The calculator is configured to create a resulting image data from the information associated with the items in the visible state. The resulting image data is transmitted to a screen of a device, thus displaying a user interface providing information about the application services.

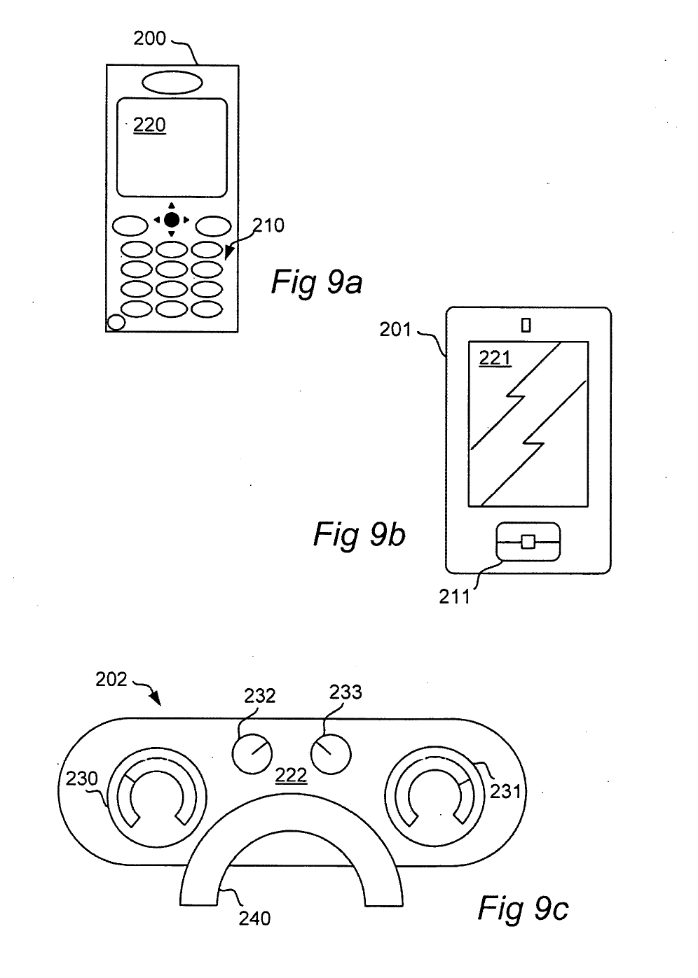

Now referring to FIGS. 9a, b and c, three different devices according to the fourth aspect of the invention are shown. FIG. 9a shows a mobile terminal 200 having a screen 220, a module according to the third aspect of the invention (not shown) and buttons 210 for a user to initialize software applications. Software applications may e.g. be a clock, a menu, a calendar, a phonebook, a media player etc. During operation, the module transmits image data to the screen 220 continuously. FIG. 9b shows a portable computer device 201, e.g. a GPS (global positioning system) receiver. The GPS receiver 201 has a screen 221 and a button 211 for a user to initialize software applications. The GPS receiver 201 also comprises a module (not shown) according to the third aspect of the invention. Software applications may e.g. be a browser, a map handler, etc. During operation, the module transmits image data to the screen 221 continuously. FIG. 9c shows the dashboard 222 of a motor vehicle 202. The user interacts with the motor vehicle 202 e.g. by means of a steering wheel 240 and a set of pedals (not shown). The motor vehicle 202 also comprises a module (not shown) according to the third aspect of the invention. For this embodiment, the dashboard 222 corresponds to a screen with reference to the description above. A number of software applications are displayed on the dashboard 222, namely four different gauges 230, 231, 232 and 233. During operation, the module transmits image data to the dashboard 222 continuously.

The devices of FIGS. 9a, b and c all share the same limitations compared to desktop computers. For the devices of FIGS. 9a, b and c the central processing unit normally implements only limited instruction sets and it runs at a low clock frequency with small or no on-chip instruction and data cache. In case of portable devices, i.e. the devices shown in FIGS. 9a and b, the reason for this is to reduce the battery consumption. Moreover, the devices of FIGS. 9a, b and c are limited in terms of available memory and how the memory architecture is setup with low bus bandwidths, slow access speeds etc. In many cases a proprietary scaled down real-time operating system is used for these devices, with very slow or even non-existing file system, limited task and thread implementations, poor timer implementations etc. The screen resolution is also typically very limited compared to a desktop device, and in most cases the application programmer cannot rely on the existence of hardware accelerated graphics like in desktop computers. The module could also be implemented in other devices, such as TV's, different household equipment etc.

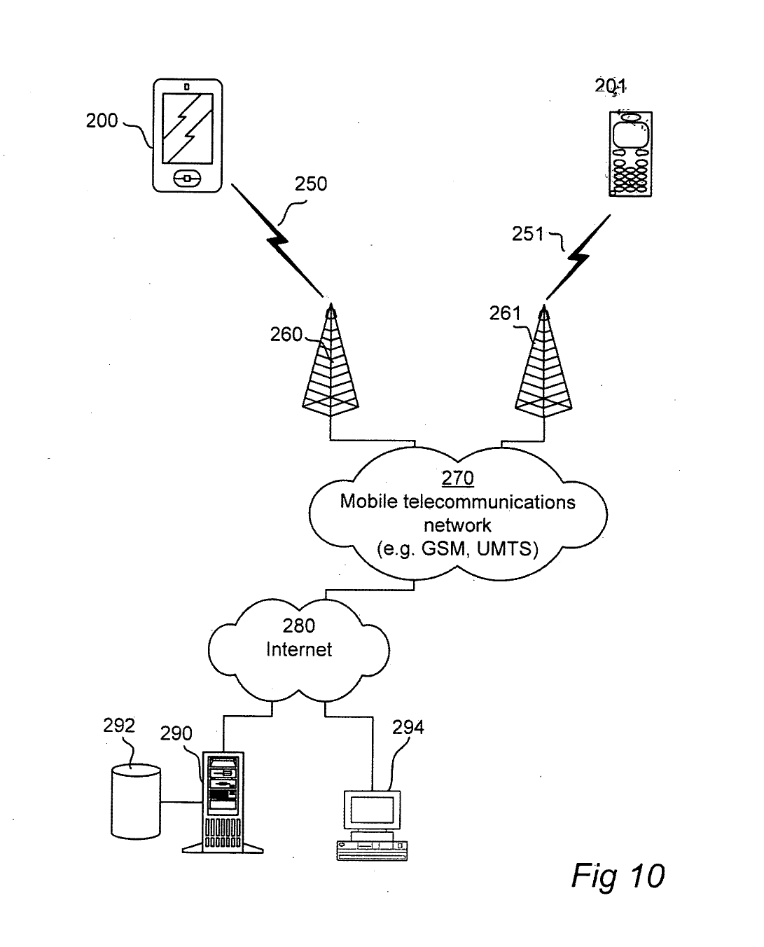

Now referring to FIG. 10, a system is shown comprising portable devices 200, 201 according to the fourth aspect of the invention. The portable devices 200, 201 are communicating with an internet server 290 via a mobile telecommunication network 270. The portable device 200 is connected to internet 280 via communication means 250, 260. In the same manner, the portable device 201 is connected to internet 280 via communication means 251, 261. The portable devices 200, 201 comprises a module according to the third aspect of the invention (not shown) for displaying software applications on the device screens. When the module is in operation, information associated with the software applications is fetched from a first memory containing application data. The first memory (not shown) is arranged within the portable devices 200, 201. However, the module also fetches graphical declarations associated with the software applications from a second memory 292. In this embodiment, the second memory 292 is connected to the internet server 290. Thus, when displaying software applications, the module need to connect to the internet server 290. The XML-file containing the graphical declarations can also be accessed via an internet client 294 connected to internet 280. Thus, a user can access a specific file containing graphical declarations by means of an internet client 294, modify the values in the file, and obtain the modifications on the screen of the users portable device 200, 201.

Although embodiments of the present invention have been described above with reference to various examples, it should be appreciated that modifications to the examples given can be made without departing from the scope of the invention as claimed.

1. A method for displaying graphical information on a screen of a device, comprising:
composing resulting image data from at least one application service; and
transmitting the composed resulting image data to the screen of the device, wherein the composing further comprises identifying items associated with each of the at least one application service, determining at least one item that is in a visible state, fetching information associated with the at least one item that is in a visible state, and calculating the resulting image data from the fetched information.

2. A method according to claim 1, wherein the identifying is performed prior to the determining of at least one item that is in a visible state, and the determining of at least one item that is in a visible state is performed prior to the fetching of information.

3. A method according to claim 2, wherein the fetching of information includes only fetching information associated with the at least one item that is determined to be in a visible state.

4. A method according to claim 1, wherein the fetching of information further comprises: fetching data associated with each of the at least one item that is determined to be in the visible state from a first memory, and fetching graphical declarations associated with each of the at least one item that is determined to be in the visible state from a second memory.

5. A method according to claim 4, wherein the fetching of graphical declarations further comprises connecting to a remote server, said server comprising the second memory.

6. A method according to claim 1, further comprising calculating at least one attribute of each identified item, wherein the attribute is selected from a group consisting of position, size and rotation.

7. A method according to claim 1, wherein the determining of at least one item that is in a visible state further comprises: determining items which are in a non-visible state, and determining items which are in a partially visible state.

8. A method according to claim 1, further comprising receiving command data corresponding to an event triggered by input data, wherein the composing of the resulting image data is repeated for every received command data.

9. A computer program product comprising a program including program code segments stored in a computer readable medium, the program code segments being adapted to perform the method of claim 1 when the program is run on a computer.

10. A module for displaying graphical information on a screen of a device, comprising:
a compositor configured to compose resulting image data from at least one application service, and
a transmitter configured to transmit the resulting image data to the screen of the device, wherein the compositor further comprises an identifier configured to identify items associated with each of the at least one application service, a determinator configured to determine at least one item that is in a visible state, a fetching device configured to fetch information associated with the at least one item that is determined to be in the visible state, and a calculator configured to calculate the resulting image data from the fetched information.

11. A module according to claim 10, wherein the fetching device only fetches information associated with the at least one item that is determined to be in a visible state.

12. A module according to claim 11, wherein the fetching device comprises a first fetching device configured to fetch data associated with each of the at least one item that is determined to be in the visible state from a first memory, and a second fetching device configured to fetch graphical declarations associated with each of the at least one item that is determined to be in the visible state from a second memory.

13. A module according to claim 12, wherein the second memory is arranged on a remote server.

14. A module according to claim 10, further comprising a second calculator configured to calculate at least one attribute of each identified item, wherein the attribute is selected from a group consisting of position, size and rotation.

15. A module according to claim 10, wherein the determinator is further configured to determine items which are in a non-visible state, and to determine items which are in a partially visible state.

16. A module according to claim 10, further comprising a receiver configured to receive command data corresponding to an event triggered by input data, wherein the command data is configured to control the compositor.

17. A device comprising:
a device for initializing at least one application service;
a module according to claim 10; and
a screen configured to display the resulting image data.

18. A device according to claim 17, wherein the device is a mobile terminal.

19. A system comprising a device according to claim 17 and a remote server which is connected to the device, wherein the remote server is storing information associated with the at least one application service.

20. A method according to claim 1, wherein the fetching of information includes only fetching information associated with the at least one, item that is determined to be in a visible state.

21. A module according to claim 10, wherein the fetching device comprises a first fetching device configured to fetch data associated with each of the at least one item that is determined to be in the visible state from a first memory, and a second fetching device configured to fetch graphical declarations associated with each of the at least one item that is determined to be in the visible state from a second memory.

22. A system comprising a device according to claim 18 and a remote server which is connected to the device, wherein the remote server is storing information associated with the at least one application service.
